(19) United States
(12) Patent Application Publication
(10) Pub. No.: US 2006/0011547 A1
(43) Pub. Date: Jan. 19, 2006

(54) Methods of separating components in treatment fluids

(76) Inventor: Stephen A. Bell, Houston, TX (US)

Correspondence Address: CRAIG W. RODDY;HALLIBURTON ENERGY SERVICES, P.O. BOX 1431, DUNCAN, OK, 73536-0440, US

(21) Appl. No.: 10/889,739

(22) Filed: Jul. 13, 2004

(51) Int. Cl. B01D 15/08

(52) U.S. Cl. 210/656; 436/161; 210/635

(57) ABSTRACT

The present invention relates to the separation of components in treatment fluids. More particularly, the present invention relates to the use of a field test that comprises separating components of treatment fluids that have varying molecular weights. In some embodiments, the present invention provides methods of separating components from a sample of a treatment fluid as part of a field test that comprise applying the sample of the treatment fluid to a chromatographic column, wherein the sample comprises components having varying molecular weights; and applying an eluent to the chromatographic column so as to separate the components as part of a field test. In other embodiments, the present invention provides methods of determining the composition of a treatment fluid

### BACKGROUND

The present invention relates to the separation of components in treatment fluids. More particularly, the present invention relates to the use of a field test that comprises separating components of treatment fluids that have varying molecular weights.

Treatment fluids commonly are used in a variety of subterranean operations. As used herein, “treatment fluid” includes drilling fluids, drill-in fluids, acidizing fluids, stimulation fluids, completion fluids, cementing fluids, and other fluids known to those of ordinary skill in the art for use in subterranean operations. One example of a treatment fluid is a drilling fluid. The process of drilling a well bore penetrating a subterranean formation typically requires the use of a drilling fluid. During the drilling process, the drilling fluid is passed down the inside of the drill string, exits through the drill bit, and returns to the surface through the annulus between the drill string and the well bore. Among other things, the circulating drilling fluid lubricates the drill bit, carries drill cuttings to the surface, and balances the formation pressure exerted on the well bore.

To improve or enhance at least one property of a treatment fluid, a wide variety of additives may be added thereto. Examples of conventional treatment fluid additives include salts, shale stabilizers, emulsifying agents, viscosifiers, filtration control materials, lost circulation materials, corrosion inhibitors, weighting agents, and numerous other additives known to those skilled in the art.

To ensure a successful well treatment (e.g., a drilling operation), the properties of the treatment fluid may be continually measured and adjusted at the rig site. In particular, chemical analysis of a drilling fluid may be performed so that the desired characteristics of the drilling fluid formulation may be maintained as needed in the drilling operation. For instance, the drilling fluid may be analyzed at the rig site using a wide variety of analysis methods, such as a Kjeldahl analysis, retort analysis, or chemical titration. However some drilling fluids may contain additives that are chemically similar. As used herein, “chemically similar” includes additives containing similar functional groups that have similar chemical and/or physical properties. Chemically similar additives also may be present in other subterranean treatment fluids. Chemical analysis of these drilling fluids will not yield the quantitative measurement of the amounts of each of these chemically similar additives without further detailed analysis. Conventional methods for analyzing drilling fluids to determine the amount of each of the chemically similar additives in the drilling fluid are laboratory-based, e.g., gel-permeation chromatography (“GPC”), high-performance liquid chromatography (“HPLC”), and gas chromatography (“GC”). These techniques require that a sample of the fluid to be tested be taken to a laboratory for analysis. Unlike analysis methods, such as a Kjeldahl analysis, these laboratory-based methods may result in inefficiencies in control of the drilling fluid formulation, inter alia, because of the turnaround time for receipt of test results from the laboratory.

### SUMMARY

The present invention relates to the separation of components in treatment fluids. More particularly, the present invention relates to the use of a field test that comprises separating components of treatment fluids that have varying molecular weights using.

In one embodiment, the present invention provides a method of separating components from a sample of a treatment fluid as part of a field test that comprises applying the sample of the treatment fluid to a chromatographic column, wherein the sample comprises components having varying molecular weights; and applying an eluent to the chromatographic column so as to separate the components as part of a field test.

In another embodiment, the present invention provides a method of determining the composition of a treatment fluid that comprises applying a sample of the treatment fluid to a chromatographic column, wherein the sample comprises components having varying molecular weights; applying an eluent to the chromatographic column so as to separate the components as part of a field test; collecting fractions that elute through the chromatographic column subsequent to applying the eluent to the chromatographic column; and analyzing the fractions to determine the composition of the treatment fluid.

In yet another embodiment, the present invention provides a method of separating components from a sample of a treatment fluid as part of a field test that comprises applying the sample of the treatment fluid to a chromatographic column containing dextran-based packing, wherein the sample comprises components having varying molecular weights; and applying an eluent to the chromatographic column so as to separate the components as part of a field test.

The features and advantages of the present invention will be readily apparent to those skilled in the art upon a reading of the detailed description that follows.

### DETAILED DESCRIPTION

The present invention relates to the separation of components in treatment fluids. More particularly, the present invention relates to the use of a field test that comprises separating components of treatment fluids that have varying molecular weights. As used herein, a “field test” includes methods performed in the field at or near a job and/or rig site, wherein samples are analyzed, tested, and/or the like without the use of complex laboratory equipment. Unlike conventional methodologies for separating components from treatment fluids, the methods of the present invention provide a field test for separating components from a drilling fluid that does not require submission of a sample of the treatment fluid to a laboratory for testing. Thus, efficiency in the control of the treatment fluid formulation may be achieved.

In some embodiments, the present invention may provide a method of separating components from a sample of a treatment fluid as part of a field test that comprises applying the sample of the treatment fluid to a chromatographic column, wherein the sample comprises components having varying molecular weights; and applying an eluent to the chromatographic column so as to separate the components as part of a field test.

Generally, the treatment fluids that are suitable for use in conjunction with the present invention include drilling fluids, drill-in fluids, acidizing fluids, stimulation fluids, completion fluids, cementing fluids, and other fluids known to those of ordinary skill in the art for use in subterranean operations. Such fluids may be aqueous-based fluids, oil-based fluids, emulsions, or the like. In some embodiments, the sample may comprise API filtrate from the treatment fluid that is collected using known methodologies. The API filtrate may be collected in accordance with API Recommended Practice 13B-1, First Edition, June 1990. As those of ordinary skill in the art will appreciate, solids and particles in the sample of the treatment may adversely affect the methods of the present invention, inter alia, by preventing flow through the chromatographic column. In some embodiments, the sample of the treatment fluid may be solids- and particles-free.

The methods of the present invention may be able to separate a variety of components contained in a sample of a treatment fluid, wherein the components have varying molecular weights. In particular, according to the methods of the present invention, the components of the sample of the treatment fluid may be separated based upon the size of the molecules of the components. For example, the components may comprise at least one additive chosen from polymeric additives (e.g., polyacrylamides), small molecules (e.g, glycols), salts (e.g., sodium or calcium chlorides), or combinations thereof. As used herein, “small molecules” includes moieties considered to have a unique non-repeating structure. In some embodiments, the components may be chemically similar additives that have varying molecular weights. For example, a treatment fluid may contain a plurality of polymeric additives that are chemically similar, wherein the polymeric additives have varying molecular weights. In other embodiments, the components may be treatment fluid additives that are not chemically similar but have varying molecular weights, such as a polymeric additive and a salt.

The chromatographic column may be any suitable chromatographic column that does not interact with the components of the treatment fluid or dissolve in water. Examples of suitable chromatographic columns include, but are not limited to, those constructed from plastic or glass. In some embodiments, the chromatographic column may be constructed from hardened polypropylene. As will be understood by those skilled in the art, the chromatographic column should have a mechanism to hold the packing in place, e.g., the column may have a fritted disc disposed therein. Furthermore, the dimensions of the chromatographic column may vary based on a number of factors, including the particular components to be separated and the relative size of their molecules as well as other factors known to those of ordinary skill in the art.

Generally, the chromatographic column should contain any packing suitable for size-exclusion chromatography so long as the packing does not undesirably interact with the components of the sample and is not soluble in water. Examples of suitable packing include, but are not limited to, agarose-based packing, dextran-based packing, cellulose-based packing, and combinations thereof. In some embodiments, these packings may comprise crosslinked dextran. An example of a suitable packing that comprises cross-linked dextran is “SEPHAROSE® CL-2B” gel-filtration media, which is commercially available from Sigma-Aldrich Corporation, St. Louis, Mo. Factors that determine the type and amount of packing that will be suitable for a particular application include, but are not limited to, the ability of the packing to separate molecules within a given molecular weight range of interest and other factors known to those skilled in the art. For example, in some embodiments, it may be desired to separate polymeric additives from a sample of a treatment fluid, wherein the first polymeric additive has a molecular weight in the range of from about 200,000 to about 500,000 and the second polymeric additive has a molecular weight in the range of from about 5,000,000 to about 10,000,000. In these embodiments, a packing material that comprises cross-linked dextran, e.g., “SEPHAROSE® CL-2B” gel-filtration media, may be used. One of ordinary skill in the art, with the benefit of this disclosure, will be able to determine the appropriate type and amount of packing to use for a particular application.

Generally, prior to applying the sample of the treatment fluid to the chromatographic column, the chromatographic column may be equilibrated. In some embodiments, equilibration of the chromatographic column includes applying an equilibrating fluid to the chromatographic column, wherein the equilibrating fluid does not interact with the components to be analyzed or the packing materials. Suitable equilibrating fluids include, but are not limited to, aqueous-based fluids and nonaqueous-based fluids. Examples of suitable nonaqueous-based fluids include organic solvents, such as tetrahyrdrofuran (“THF”) and N-methyl pyrrolidone (“NMP”). In some embodiments, the aqueous-based fluid may comprise a salt, such as sodium chloride, calcium chloride, calcium bromide, zinc bromide, and mixtures thereof. One of ordinary skill in the art, with the benefit of this disclosure, will be able to determine the appropriate equilibrating fluid for a particular application.

Once the chromatographic column has been equilibrated, the sample of the treatment fluid should be applied to the chromatographic column. The quantity of the sample applied to the chromatographic column will vary dependent on a variety of factors, including the size of the chromatographic column, the amount of packing material, and other factors known to those of ordinary skill in the art.

According to the methods of the present invention, an eluent should be applied to the chromatographic column, so as to separate the components of the sample. Generally, the eluent may be applied to the chromatographic column simultaneously with or after contacting the chromatographic column with the sample. By passing the eluent through the chromatographic column, the components should be fractionally separated based on their relative size. For example, a first component with a larger molecular weight relative to a second component should elute through the column prior to the second component. Therefore, a plurality of fractions should be collected as they elute through the column, wherein the components having varying molecular weights are separated into the plurality of fractions.

The eluents used in the methods of the present invention may be any suitable eluent that does not interact with the components to be analyzed or the packing material. Suitable eluents include, but are not limited to, aqueous-based fluids and nonaqueous-based fluids. Examples of suitable nonaqueous-based fluids include organic solvents, such as tetrahyrdrofuran (“THF”) and N-methyl pyrrolidone (“NMP”). In some embodiments, the aqueous-based fluid may comprise a salt, such as sodium chloride, calcium chloride, calcium bromide, zinc bromide, and mixtures thereof. In some embodiments, the eluent may be the same as the equilibration fluid. The quantity of the eluent to use for a particular application generally depends upon the size of the chromatographic column, the particular components to be separated, the relative size of their molecules, and other factors known to those of ordinary skill in the art.

Once the components of the sample have been separated into different fractions, the fractions may be analyzed to determine the amount of each of the components in the treatment fluid. Any suitable method may be used to analyze the fractions, including a Kjeldahl analysis, retort analysis, or chemical titration.

In another embodiment, the present invention provides a method of determining the composition of a treatment fluid that comprises applying a sample of the treatment fluid to a chromatographic column, wherein the sample comprises components having varying molecular weights; applying an eluent to the chromatographic column so as to separate the components as part of a field test; collecting fractions that elute through the chromatographic column subsequent to applying the eluent to the chromatographic column; and analyzing the fractions to determine the composition of the treatment fluid.

In yet another embodiment, the present invention provides a method of separating components from a sample of a treatment fluid as part of a field test that comprises applying the sample of the treatment fluid to a chromatographic column containing dextran-based packing, wherein the sample comprises components having varying molecular weights; and applying an eluent to the chromatographic column so as to separate the components as part of a field test.

To facilitate a better understanding of the present invention, the following examples of certain embodiments are given. In no way should the following examples be read to limit, or define, the scope of the invention.

### EXAMPLES

The following example was performed to separate two chemically similar components in a drilling fluid. A sample drilling fluid was prepared that comprised about 1 pound per barrel (“PPB”) of a high-molecular-weight polymeric additive and about 4 PPB of a low-molecular-weight polymeric additive. These two polymeric additives were chemically similar. And the high-molecular-weight polymeric additive had a molecular weight in the range of from about 5,000,000 to about 10,000,000, and the low-molecular-weight polymeric additive had a molecular weight in the range of from about 200,000 to about 500,000. A series of tests were run using 0.5 ml, 0.75 ml, and 1.0 ml of API filtrate, respectively.

The following procedure was used for this series of tests, the results of which are provided in Table 1 through Table 3. A chromatographic column was prepared as follows. First, a hardened polypropylene column having a diameter of 1 inch and a length of 9 inches was packed with “SEPHAROSE® CL-2B” gel-filtration media. The chromatograph column contained two fritted discs disposed therein. Furthermore, the chromatographic column had a volume of 28 ml between the two fritted discs, and 6 ml of headroom above the top fritted disc. Next, the chromatographic column was equilibrated by applying about 10 ml of an equilibrating fluid to the chromatographic column and allowing it to drip through the column. The equilibrating fluid was an aqueous-based fluid that comprised about 20% sodium chloride by weight of the equilibrating fluid.

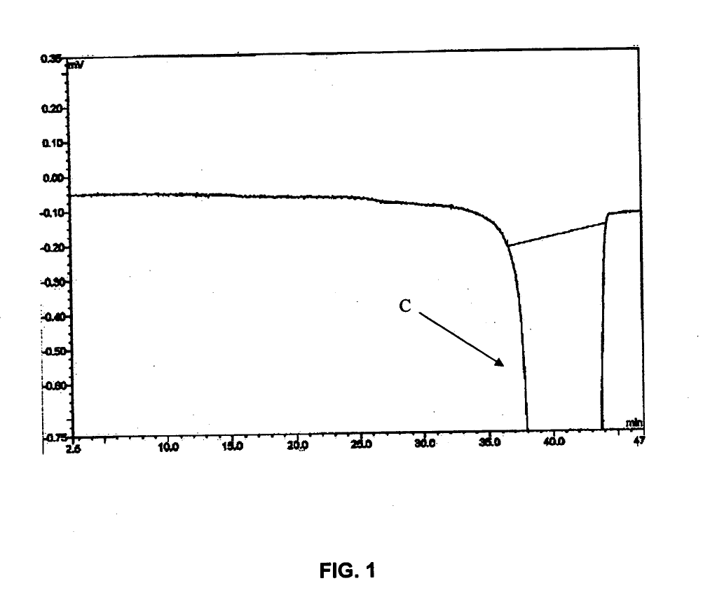

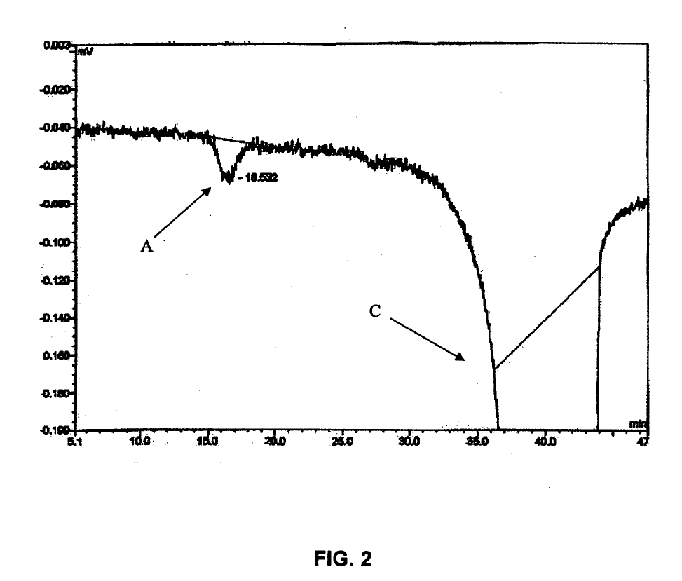

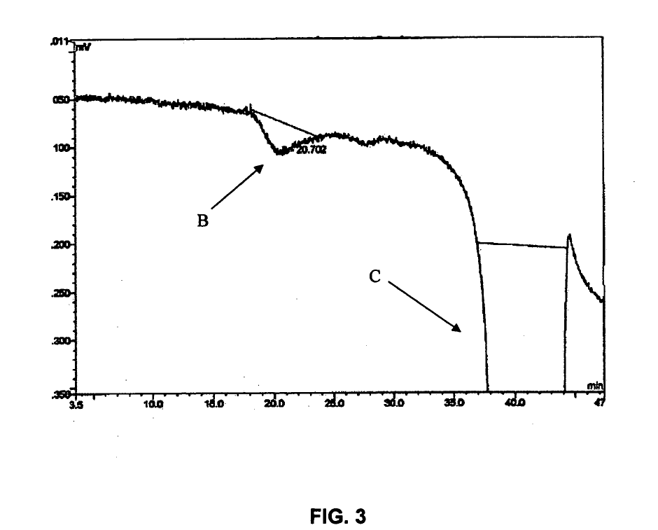

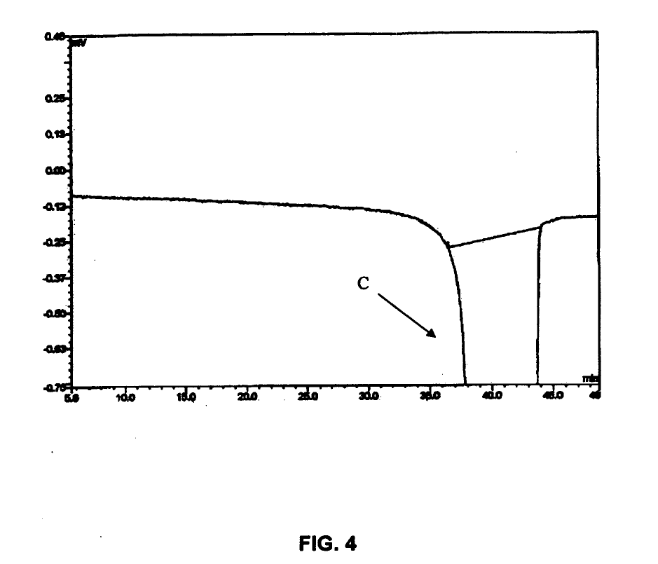

To the prepared chromatographic column, about 0.5 ml to about 1.0 ml of API filtrate from the drilling fluid was applied to the chromatographic column and allowed to drain through the column. Next, about 15 ml to about 30 ml of the equilibrating fluid was applied to the column as an eluent and allowed to drain through. The eluent discharged from the chromatographic column was collected in three fractions of about 5 ml to about 10 ml. Furthermore, an additional amount of the equilibrating fluid was applied to the column as an eluent, allowed to drain through, and collected as Fraction No. 4. Fraction No. 1 through Fraction No. 4 were analyzed individually by a GPC to confirm that the two polymeric additives were separated. The GPC indicated that the high-molecular-weight polymeric additive and the low-molecular-weight polymeric additive separated into Fraction No. 2 and Fraction No. 3, respectively. The GPC analyses of the respective fractions are shown in FIG. 1 through FIG. 4, respectively. The peak on FIG. 2 represented by reference character A indicates the presence of the high-molecular-weight polymeric additive in Fraction No. 2. The peak on FIG. 3 illustrated by reference character B indicates the presence of the low-molecular-weight polymeric additives. The common peak on FIG. 1 through FIG. 4 illustrated by reference character C indicates the presence of the equilibrating fluid in Fraction No. 1 through Fraction No. 4.

Furthermore, Fraction No. 2 and Fraction No. 3 were analyzed individually by a Kjeldahl analysis to determine the amount of the polymeric additives in the drilling fluid. The results for the tests performed with 0.5 ml of filtrate are tabulated in Table 1 below.

TABLE 1

| | | LOW-MOLECULAR- |
|---|---|---|
| | HIGH-MOLECULAR- | WEIGHT |
| | WEIGHT POLYMERIC | POLYMERIC |
| | ADDITIVE (PPB) | ADDITIVE (PPB) |
| Sample Drilling Fluid | 1 | 4 |
| Fraction No. 1 | 0 | 0 |
| Fraction No. 2 | 1.0 | 0 |
| Fraction No. 3 | 0 | 3.8 |
| Fraction No. 4 | 0 | 0 |

The results for the tests performed with 0.75 ml of filtrate are tabulated below in Table 2.

TABLE 2

| | | LOW-MOLECULAR- |
|---|---|---|
| | HIGH-MOLECULAR- | WEIGHT |
| | WEIGHT POLYMERIC | POLYMERIC |
| | ADDITIVE (PPB)) | ADDITIVE (PPB) |
| Sample Drilling Fluid | 1 | 4 |
| Fraction No. 1 | 0 | 0 |
| Fraction No. 2 | 1.0 | 0 |
| Fraction No. 3 | 0 | 3.6 |
| Fraction No. 4 | 0 | 0 |

The results for the tests performed with 1.0 ml of filtrate are tabulated below in Table 3.

TABLE 3

| | | LOW-MOLECULAR- |
|---|---|---|
| | HIGH-MOLECULAR- | WEIGHT |
| | WEIGHT POLYMERIC | POLYMERIC |
| | ADDITIVE (PPB) | ADDITIVE (PPB) |
| Sample Drilling Fluid | 1 | 4 |
| Fraction No. 1 | 0 | 0 |
| Fraction No. 2 | 0.9 | 0 |
| Fraction No. 3 | 0 | 3.8 |
| Fraction No. 4 | 0 | 0 |

Thus, these examples indicate that separation of chemically similar components in a drilling fluid may be achieved by utilizing the methods of the present invention.

Therefore, the present invention is well adapted to carry out the objects and attain the ends and advantages mentioned as well as those that are inherent therein. While numerous changes may be made by those skilled in the art, such changes are encompassed within the spirit of this invention as defined by the appended claims.

What is claimed is:

1. A method of separating components from a sample of a treatment fluid as part of a field test, comprising:
applying the sample of the treatment fluid to a chromatographic column, wherein the sample comprises components having varying molecular weights; and
applying an eluent to the chromatographic column so as to separate the components as part of a field test.

2. The method of claim 1 further comprising equilibrating the chromatographic column.

3. The method of claim 2 wherein equilibrating the chromatographic column comprises applying an equilibrating fluid to the chromatographic column.

4. The method of claim 3 wherein the equilibrating fluid is an aqueous-based fluid or a nonaqueous-based fluid.

5. The method of claim 3 wherein the equilibrating fluid is an aqueous-based fluid that comprises a salt.

6. The method of claim 1 further comprising collecting fractions that elute through the chromatographic column.

7. The method of claim 1 wherein the treatment fluid is aqueous-based, oil-based, or an emulsion.

8. The method of claim 1 wherein the treatment fluid is a drilling fluid.

9. The method of claim 1 wherein the components comprise a polymeric additive, a small molecule, a salt, or a combination thereof.

10. The method of claim 1 wherein the components comprise a first polymeric additive and a second polymeric additive.

11. The method of claim 10 wherein the first polymeric additive has a molecular weight of from about 200,000 to about 500,000, and the second polymeric additive has a molecular weight of from about 5,000,000 to about 10,000,000.

12. The method of claim 1 wherein the components are chemically similar.

13. The method of claim 1 wherein the components are fractionally separated.

14. The method of claim 1 wherein the eluent is an aqueous-based fluid or a nonaqueous-based fluid.

15. The method of claim 1 wherein the eluent is an aqueous-based fluid that comprises a salt.

16. The method of claim 1 wherein the chromatographic column contains packing.

17. The method of claim 16 wherein the packing comprises agarose-based packing, dextran-based packing, cellulose-based packing, or a combination thereof.

18. The method of claim 16 wherein the packing comprises cross-linked dextran.

19. The method of claim 1 further comprising determining the amount of the components in the treatment fluid.

20. A method of determining the composition of a treatment fluid, comprising
applying a sample of the treatment fluid to a chromatographic column, wherein the sample comprises components having varying molecular weights;
applying an eluent to the chromatographic column so as to separate the components as part of a field test;
collecting fractions that elute through the chromatographic column subsequent to applying the eluent to the chromatographic column; and
analyzing the fractions to determine the composition of the treatment fluid.

21. The method of claim 20 further comprising equilibrating the chromatographic column.

22. The method of claim 21 wherein equilibrating the chromatographic column comprises applying an equilibrating fluid to the chromatographic column.

23. The method of claim 22 wherein the equilibrating fluid is an aqueous-based fluid or a nonaqueous-based fluid.

24. The method of claim 22 wherein the equilibrating fluid is an aqueous-based fluid that comprises a salt.

25. The method of claim 20 wherein the treatment fluid is aqueous-based, oil-based, or an emulsion.

26. The method of claim 20 wherein the treatment fluid is a drilling fluid.

27. The method of claim 20 wherein the components comprise a polymeric additive, a small molecule, a salt, or a combination thereof.

28. The method of claim 20 wherein the components comprise a first polymeric additive and a second polymeric additive.

29. The method of claim 28 wherein the first polymeric additive has a molecular weight of from about 200,000 to about 500,000, and the second polymeric additive has a molecular weight of from about 5,000,000 to about 10,000,000.

30. The method of claim 20 wherein the components are chemically similar.

31. The method of claim 20 wherein the components are fractionally separated.

32. The method of claim 20 wherein the eluent is an aqueous-based fluid or a nonaqueous-based fluid.

33. The method of claim 20 wherein the eluent is an aqueous-based fluid that comprises a salt.

34. The method of claim 20 wherein the chromatographic column contains packing.

35. The method of claim 34 wherein the packing comprises agarose-based packing, dextran-based packing, cellulose-based packing, or a combination thereof.

36. The method of claim 34 wherein the packing comprises cross-linked dextran.

37. A method of separating components from a sample of a treatment fluid as part of a field test, comprising:
applying the sample of the treatment fluid to a chromatographic column containing dextran-based packing, wherein the sample comprises components having varying molecular weights; and
applying an eluent to the chromatographic column so as to separate the components as part of a field test.

38. The method of claim 37 further comprising equilibrating the chromatographic column.

39. The method of claim 38 wherein equilibrating the chromatographic column comprises applying an equilibrating fluid to the chromatographic column.

40. The method of claim 39 wherein the equilibrating fluid is an aqueous-based fluid or a nonaqueous-based fluid.

41. The method of claim 39 wherein the equilibrating fluid is an aqueous-based fluid that comprises a salt.

42. The method of claim 37 further comprising collecting fractions that elute through the chromatographic column.

43. The method of claim 37 wherein the treatment fluid is aqueous-based, oil-based, or an emulsion.

44. The method of claim 37 wherein the treatment fluid is a drilling fluid.

45. The method of claim 37 wherein the components comprise a polymeric additive, a small molecule, a salt, or a combination thereof.

46. The method of claim 37 wherein the components comprise a first polymeric additive and a second polymeric additive.

47. The method of claim 46 wherein the first polymeric additive has a molecular weight of from about 200,000 to about 500,000, and the second polymeric additive has a molecular weight of from about 5,000,000 to about 10,000,000.

48. The method of claim 37 wherein the components are chemically similar.

49. The method of claim 37 wherein the components are fractionally separated.

50. The method of claim 37 wherein the eluent is an aqueous-based fluid or a nonaqueous-based fluid.

51. The method of claim 37 wherein the eluent is an aqueous-based fluid that comprises a salt.

52. The method of claim 37 wherein the dextran-based packing is cross-linked dextran.

53. The method of claim 37 further comprising determining the amount of the components in the treatment fluid.
